(19) United States
(12) Patent Application Publication
(10) Pub. No.: US 2021/0065256 A1
(43) Pub. Date: Mar. 4, 2021

(54) AUTOMATED SYSTEMS AND METHODS FOR FACILITY MANAGEMENT

(71) Applicant: Lexis B. SHONTZ, Hermosa Beach, CA (US)

(72) Inventor: Lexis B. SHONTZ, Hermosa Beach, CA (US)

(21) Appl. No.: 17/002,584

(22) Filed: Aug. 25, 2020

Related U.S. Application Data
(60) Provisional application No. 63/039,369, filed on Jun. 15, 2020.
(60) Provisional application No. 62/895,054, filed on Sep. 3, 2019.

(51) Int. Cl. G06Q 30/02; G06K 7/14; G06F 16/955; G06Q 30/06; G16Y 40/20

(52) U.S. Cl. CPC G06Q 30/0281; G06K 7/1417; G16Y 40/20; G06Q 30/0623; G06F 16/9554

(57) ABSTRACT

Systems and methods for automated management of facility operations and information are described. A portal is provided which stores significant information about the facility, such as regulatory, safety, operational and product information. Users may access the portal by scanning a scannable placard, which may use a QR code. Portal information may be customized based on user type or identity. Useful displays are generated which overlay live, or near-live, sensor readings onto maps, blueprints or images of the facility. Facility operators can use the systems and methods to automate repurchase of materials for the facility. Regulators, consumers, first responders, and others can use the portal to obtain, at a glance, all key information about the facility. Safety is substantially enhanced by the ability to collate all important safety information in one location, and to overlay such information with live readings from the facility.

### CROSS-REFERENCE TO RELATED APPLICATIONS

The present application claims priority under 35 U.S.C. § 119 to U.S. Provisional Patent Application Nos. 62/895,054, filed Sep. 3, 2019, and 63/039,369, filed Jun. 15, 2019. The entire contents of these applications are incorporated by reference herein in their entirety.

### FIELD OF THE INVENTION

This invention relates to automated systems and methods for facility management, including systems and methods for managing facility information, systems and methods for providing access to facility information, systems and methods for monitoring and controlling facility operations, systems and methods for managing facility safety infrastructure, and systems and methods for providing information about products produced at a facility to consumers (such as “seed to sale” or “cradle to grave” information about the ingredients used at the facility).

### DESCRIPTION OF RELATED ART

QR (or “Quick Response”) codes were invented in the 1990s, as a way of tracking vehicle parts during automobile manufacturing. QR codes store information as a series of “dots” in a two-dimensional array. Compared to conventional barcodes, which can only store <100 characters, QR codes can store several thousand alphanumeric characters. This makes QR codes ideal for storing large sequences of alphanumeric characters in a relatively compact array.

Significantly, the QR code's large capacity allows it to store Uniform Resource Identifiers (“URIs”) and Uniform Resource Locators (“URLs”) for objects or locations on a computer network, such as the Internet. Moreover, a QR code can easily be decoded by any device with a camera and rudimentary image-processing capability. Virtually all modern smartphones are capable of decoding QR codes. Thus, almost the entire population of the United States carries, at nearly all times, a device that can be used to decode and interact with QR codes.

Recognizing this, various attempts have been made to use QR codes to reach consumers. For instance, advertisers have inserted QR codes into advertisements. These QR codes typically encode the URL for the advertiser's website. When a consumer scans the QR code, it takes them to the advertiser's website, bypassing the process of manually typing in a URL. QR codes have also been used, inter alia: (i) to store attendee information on tickets for concerts and sporting events; (ii) to store the SSID and login information for wireless networks, allowing instant login via QR code scan; and (iii) as gameplay/story elements in popular video games.

### BRIEF SUMMARY OF THE INVENTION

The present Application relates to automated systems and methods for facility management. It also relates to systems and methods for controlling and monitoring operations at a facility, based on data generated by sensors embedded at the facility.

In some embodiments, systems and methods are provided which permit facility operators to store safety, regulatory, production, and other information relevant to the facility's operations in a convenient electronic location. In some embodiments, the information is stored in a “portal” linked to the facility. In some embodiments, the portal may be accessed by scanning a QR code or another type of 1D or 2D bar code. In some embodiments, the portal may be accessed directly over the Internet by authorized users, such as employees, regulators or first responders. In some embodiments, the portal may be accessed by scanning an RFID chip, a contactless smart card (CSC), a near-field communication (NFC) device, or another like device.

In some embodiments, the facility is provided with embedded sensors to monitor conditions at the facility. These sensors may include pressure sensors, temperature sensors, weight sensors, light sensors, motion sensors, infrared sensors, vibration sensors, smoke sensors, CO sensors, CO₂ sensors, other gas or chemical sensors, RFID tag readers, cameras, and other types of sensors. In some embodiments, data from the sensors may be monitored via the portal. In some embodiments, facility operations may be automated based on data from the sensors. For instance, in some embodiments, the system may automatically repurchase a material if a sensor indicates that the facility is running low on that material. In some embodiments, the system may trigger alarms, stop or modify facility operations, contact first responders, or “lock down” portions of the facility if a dangerous condition is detected. In some embodiments, the system may cause an exhaust fan, such as a C1D1 exhaust fan, to vent air from an area of the facility in which a dangerous concentration of gases (such as flammable gases) is detected. The system may also permit remote monitoring and control of such exhaust fans. In some embodiments, the system may automatically manage the supply chain of materials needed at the facility based on data from the sensors, desired production levels, historical information, and/or other factors.

In some embodiments, data from the sensors is combined with other information about the facility to provide a more useful picture to the relevant user. For instance, in some embodiments, sensor readings indicating levels of hazardous materials may be overlaid with a map of the facility, showing at a glance which areas of the facility are most dangerous. In some embodiments, sensor readings may be overlaid with a “virtual walkthrough” of the interior of the facility. In some embodiments, sensor readings indicating a dangerous condition may be coupled with protocols, procedures, data sheets, or other information detailing how to safely handle the condition.

In some embodiments, information about the facility is made available to end-consumers. For instance, in some embodiments, a product manufactured at the facility may be branded with a QR code, or another 1D or 2D barcode, that is linked to the facility. A consumer may scan the code and immediately be taken to a “portal” with relevant information about the facility, such as the production practices employed by the facility, the ingredients used by the facility, the conditions under which the product was manufactured, and the like. Additionally, in some embodiments, the consumer may be provided with information about the product produced by the facility, including information about the purity of the product, the specific ingredients used to produce the product, and the characteristics of those ingredients (e.g., soil sample information, water sample information, genetic information, pesticide information, and the like). In some embodiments, the portal may provide “cradle to grave” or “seed to sale” information about the products produced at the facility—i.e., the full range of available information about the raw ingredients used at the facility, the manufacturing processes performed, and the products ultimately produced—to grant consumers greater transparency into the manufacturing process.

### BRIEF DESCRIPTION OF THE DRAWINGS

Referring now to the drawings, where like numerals represent like features or components:

FIG. 1 illustrates an embodiment in which a facility is equipped with embedded sensors and a scannable placard, wherein a user device is used to scan the placard.

FIG. 2 illustrates, in an embodiment, the content of a facility portal, as well as the flow of information between the facility portal, a facility operator, and user devices.

FIG. 3 illustrates an embodiment in which real-time information from a facility's sensors is overlaid with other facility information, to provide a more useful display to the user.

FIG. 4 is a flowchart depicting an embodiment in which materials are automatically repurchased for a facility, based on sensor readings at the facility.

FIG. 5 is a flowchart depicting an embodiment in which a supply chain for a facility is automatically managed based on, inter alia, sensor readings at the facility.

### DETAILED DESCRIPTION OF THE INVENTION

The present invention is described by reference to the following embodiments thereof. However, it is to be understood that those of ordinary skill in the art would recognize various modifications and versions of these embodiments. Applicant intends this disclosure to encompass all such modifications and versions that would be apparent to one of ordinary skill.

Conventionally, facility operators have satisfied their obligation to provide detailed safety information by posting physical posters or placards within the facility, and/or by storing physical compilations of the relevant documents on-site. However, there are drawbacks to these conventional techniques. First, when safety documentation is stored in a physical “book,” or posted on a physical placard, it may be difficult to access in times of emergency. Second, safety information that is physically stored on-site can only be accessed by people who are present at the facility—which prevents, e.g., first responders from reviewing the information while they are traveling to an emergency at the facility, or from using the information in training exercises, or from otherwise reviewing the information offsite. Third, physically stored safety information is static and non-interactive, meaning that it cannot be combined with other relevant information to present a more useful picture to employees, first responders, regulators, and others.

The inventor has recognized that there is a need for systems that allow facility operators to store safety information, regulatory information, and other facility information in a convenient, easily accessible electronic location; for systems that can present the safety, regulatory, and other information in a form that is more useable to employees, first responders, regulators, and others; for systems that can use real-time readings from sensors embedded within the facility to provide realtime safety information; for systems that can make all of this information available to users remotely, without requiring physical presence at the facility; for systems that can give first responders, regulators and inspectors remote access to facility information for training purposes, and/or for use in emergency situations; for systems that can use readings from sensors embedded within the facility to automate various facility operations; for systems that can provide realtime mapping of facility occupants, such as sensitive occupants or handicapped occupants, who may require extraordinary attention during emergencies; and for systems that can conveniently provide “seed to sale” or “cradle to grave” information about the products produced at a facility to consumers. The present Application addresses these, and other, needs in the art.

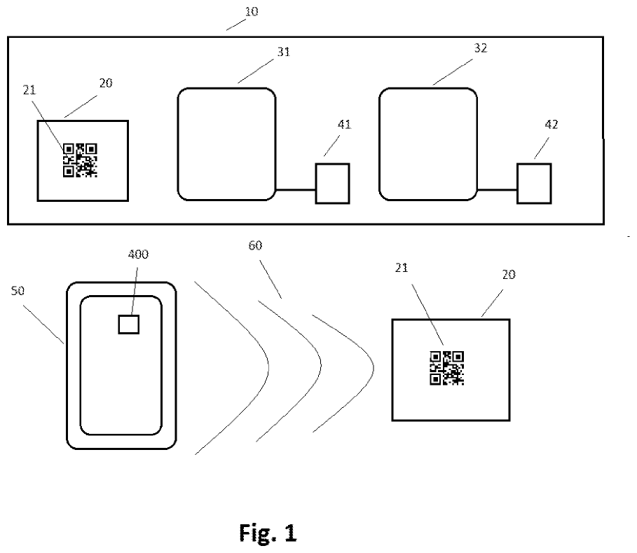

FIG. 1 depicts an embodiment of a facility 10 having a scannable placard 20. Preferably, the scannable placard 20 is mounted at a prominent, easily accessible location within the facility, such as near the entrance of the facility. In FIG. 1, only one scannable placard is shown. However, multiple scannable placards may be installed, to improve access to the scannable placards. For instance, if the facility 10 has multiple entrances, one scannable placard may be mounted near each entrance. Similarly, if the facility 10 contains multiple rooms, scannable placards may be mounted in one or more of the rooms.

In a preferred embodiment, the scannable placard 20 displays a QR code 21. The QR code may be scanned by a user device 50. The user device 50 may be any device capable of scanning a QR code, such as a smartphone, a tablet, a laptop, a smartwatch, or any other QR-capable device.

Although, in FIG. 1, the scannable placard 20 is depicted as being mounted on a wall of the facility, this is for illustrative purposes only. The scannable placard could be mounted at any location capable of being viewed by a user. For example, a large scannable placard 20 could be mounted on a roof of the facility 10, so that the placard could be viewed and scanned by helicopter or drone traffic flying overhead. This could be especially useful to first responders, who may only be able to access the facility from overhead during an emergency. Of course, as a person of skill would recognize, many other mounting locations are possible.

The QR code 21 encodes information sufficient to direct a user device 50 to a portal 100 linked to the facility. For instance, in a preferred embodiment, the QR code encodes a URL or URI which links to a web address for the portal 100. However, as those of ordinary skill in the art would know, the QR code 21 could also encode other information sufficient to direct to a user device 50 to the portal, such as an IP address, a wireless network name and/or password, a token, a key, a user name and/or password, or any other information that can provide access to the portal 100.

Although, in a preferred embodiment, the scannable placard 20 uses a QR code to encode information directing user devices 50 to the portal 100, the scannable placard is not limited to the use of QR codes. The scannable placard could also use other one-dimensional or two-dimensional barcodes, such as UPC-A, UPC-E, EAN-8, EAN-13 (for one-dimensional codes), or such as Data Matrix, PDF417, and MaxiCode (for two-dimensional codes). If barcodes other than a QR code are used, then the user device 50 should be capable of scanning the relevant barcodes.

Additionally, the scannable placard 20 may use technology other than barcodes to encode the portal information. For instance, the scannable placard 20 may include an RFID transceiver, which communicates with compatible RFID transceivers in the user device 50 to direct the device to the portal 100. Or, the scannable placard 20 may use a near-field communications (NFC) transceiver, which communicates with compatible NFC transceivers in the user device 50 to direct the device to the portal. As a person of ordinary skill would know, there are many transmitting devices that are capable of transmitting data to a user device, after the user device is brought within proximity of the transmitter. The scannable placard 20 may use any such devices, in order to transmit portal information to user devices 50 brought in proximity to the placard 20.

In operation, a user (not shown) at the facility 10 performs a scan 60 of the scannable placard 20 with the user device 50, in the manner dictated by the technology used in the placard 20. If the placard 20 uses a QR code 21, then the user scans the placard by visually scanning the QR code with a QR reading application on the user device 50. If the placard uses an NFC transceiver, then the user scans the placard by bringing the user device 50 to within the required distance of the placard 20, and reading the transmitted data in an NFC receiver application. A person of skill would recognize that the manner of scanning is dictated by the technology used.

The inventive system contemplates several different types of users, each of whom can use a user device 50 to scan the scannable placard 20. For instance, one type of user may be a first responder, such as a police officer, firefighter or EMT. Another type of user may be an employee of the facility 10. Additionally, there may be different classes of “employee” users, if required, such as management-level employees, non-management employees, etc. Another type of user could be a member of the general public. Another type of user could be a regulator or government official—e.g., an official charged with regulating the work performed at the facility 10.

In some embodiments, the user device 50 may be loaded with a reader application 400. The reader application 400 may be configured differently for different types of users. For instance, if the user is a first responder, the reader application 400 may be configured to load a version of the portal that prioritizes the display of safety-related information, such as building maps, live readings from fire, temperature, gas, smoke or other detectors, locations of gas shutoff valves and exhaust fans, locations and specifications of sprinklers, locations and specifications of fire doors and firewalls, locations of occupants who may need special attention during an emergency (e.g., handicapped (ADA), elderly or ill occupants) and the like. If the user is a regulator, the reader application 400 may be configured to load a version of the portal that prioritizes the display of regulatory information, such as Certificates of Analysis, Safety Data Sheets, safety protocols, and the like. If the user is an employee of the facility 10, the reader application 400 may be configured to load a version of the portal that prioritizes information related to work operations at the facility, such as production processes, work schedules, work assignments, product formulae, and the like. And, if the user is a member of a general public, the reader application 400 may be configured to load a version of the portal that prioritizes the display of marketing information.

Different versions of the reader application 400 may be configured to provide different types of users with different levels of access to facility information. For instance, if the user is a first responder, the reader application 400 may load a version of the portal that displays all safety-related information, but does not display business or marketing information. Similarly, if the user is a member of the general public, the reader application 400 may load a version of the portal that displays only public marketing information, and does not disclose sensitive information. A person of skill would understand that the reader application 400 may be configured in a variety of different ways, to provide appropriate access to a variety of different types of users.

In embodiments, the reader application 400 is configured to load different versions of a map of the facility 10, depending on the type of user. The reader application should be configured to load a version of the map that provides the most relevant information for each type of user, while ensuring that no user receives information they are not entitled to access. For instance, if the user is a first responder, the portal can display a map that includes safety-related information, such as the locations of gas lines and gas shutoff valves, the locations of fire extinguishers and sensors, an overlay showing live readings of gas, temperature, smoke, and other sensors, or an overlay showing live motion sensor or RFID tag readings, which can indicate the locations of people inside the facility. If the user is an employee, the portal can display a map that includes information such as work areas, break rooms/restrooms, and potential safety hazards.

If the user is a regulator, the portal can display a map that shows regulatory information, such as where regulated/dangerous materials are stored, the current levels of such materials, how such materials are being distributed and used throughout the facility, and other information which—in the absence of the portal—the regulator could only learn through a physical inspection of the facility. One advantage of this embodiment is that, if the information on the portal is adequately verified, regulators could conduct a “virtual inspection” of the facility via the portal, without having to conduct a physical inspection on-site. This benefits regulators, by saving the time and expense of a physical inspection, and benefits facility operators, by avoiding the business disruption of an on-site inspection. In some embodiments, a “virtual” inspection is triggered when a regulator scans the scannable placard 20 at the facility 10. However, in other embodiments, no on-site scan is required. For instance, a regulator could begin a “virtual” inspection by accessing the portal directly over the Internet, e.g., using an app supplied by the portal operator, or by accessing the portal operator's website. Such embodiments are especially advantageous to regulators, because they eliminate the need to visit the facility 10 altogether.

As discussed above, in some embodiments, the portal is configured to behave differently for different types of users. To accomplish this, the portal must be able to differentiate between user types. There are several ways to do this. First, the portal can be configured to insist that each user “log in” via an individual account before the portal is displayed. Each individual account can be tied to a particular user type; thus, by “logging in,” the user signals which type of user they are, and the portal can serve the appropriate version to the user. Second, the portal can display a “welcome” screen, which asks the user to identify their user type (“regulator,” “first responder,” “general public”, etc.). After the user makes their selection, the appropriate version of the portal can be displayed—although, if the user identifies themselves as a type of user that has access to sensitive information, further credentials may be demanded before the sensitive information is displayed. Third, the portal operator can distribute different versions of the reader application 400 to different types of users (e.g., one version of the reader application 400 for regulators, one version for first responders, etc.). In this embodiment, when a user accesses the portal, the reader application 400 already knows (by virtue of which “version” it is) what type of user is using the application. Thus, the reader application 400 can automatically display the appropriate version of the portal to the user. Note that these are merely illustrative embodiments of ways in which the system can differentiate between different types of users. As the person of skill would know, other options are available, and all such options are within the scope of the disclosure.

In operation, in some embodiments, a user at the facility 10 scans the scannable placard 20 with the user device 50. The user device reads, from the scannable placard, information sufficient to direct the user device 50 to the portal 100 linked to the facility 10. If the user device 50 is loaded with the reader application 400, the reader application 400 may be used to scan the placard 20. However, if the user device 50 is not loaded with the reader application 400, it may scan the placard 20 according to its built-in scanning and reading capabilities. Once the scannable placard 20 is scanned, the user device is directed automatically to the portal 100 for the facility. As discussed above, in some embodiments, the version of the portal that is displayed depends on the user type. In other embodiments, the same version of the portal is displayed for all users. In other embodiments, the portal may “default” to a general version (which, for example, may not disclose any sensitive information) when it is initially loaded, but users may subsequently elect to display a specific user version during use of the portal. In such embodiments, the system may demand credentials if the user attempts to access a version of the portal that contains sensitive information.

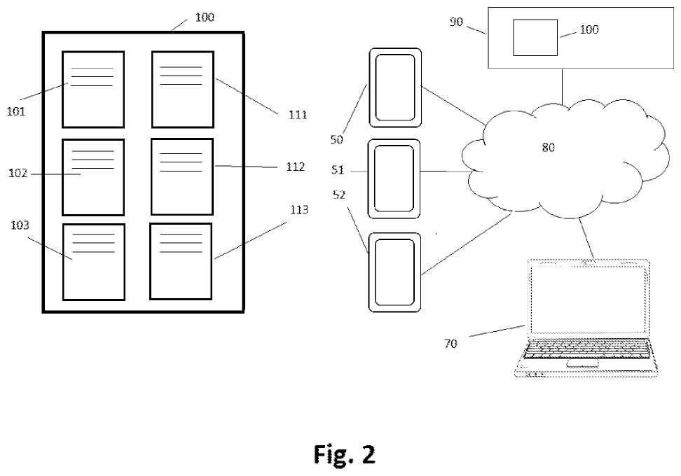

FIG. 2 illustrates the content of the portal 100, and how users and facility operators interact with the portal 100. As shown, the portal 100 contains a first set of files 101, 102 and 103, and a second set of files 111, 112, 113. While FIG. 2 depicts two sets of files, each containing three files, this is for illustrative purposes only. A person of skill would recognize that the portal 100 may contain any number of sets of files, and that each set of files may contain any number of files.

In preferred embodiments, the files stored on the portal 100 all pertain to the operations at the facility 10. The files may be grouped into different types or categories. For instance, one group of files may be “regulatory” files—i.e., files that would be of interest to regulators of the facility. Depending on the specific type of operations performed at the facility, these “regulatory” files could include Certificates of Analysis (“COAs”), Safety Data Sheets (“SDSs”), Material Safety Data Sheets (“MSDSs”), Product Safety Data Sheets (“PSDSs”), safety or regulatory placards, licensing documents, zoning documents, and the like. As a person of skill would recognize, many other types of regulatory files could be included, depending on the industry. The important point is that, in preferred embodiments, the set of “regulatory” files would contain all (or substantially all) of the information that a regulator would need or demand when conducting a site visit to the facility 10. That way, by scanning the scannable placard 20 with their user device 50, the regulator could immediately access all relevant information through portal 100.

In embodiments, another group of files on the portal 100 can be “product” files. Such a grouping would be particularly appropriate if the facility 10 manufactures, processes or prepares agricultural, pharmaceutical or nutraceutical products. However, product files could also be provided for other types of products. Product files contain information about the origin and characteristics of the products made at the facility, and/or about the components or ingredients used at the facility to make those products. For instance, product files could include identifying information (such as batch numbers) for each batch of products made at the facility; the dates when each batch was produced; purity information for each batch; Certificates of Analysis for each batch; nutritional information for each batch; relevant conditions at the facility when each batch was produced (temperature, humidity, pH, etc.); photographs of samples of each batch; and information about the specific ingredients used to generate each batch. As for ingredients, detailed information can be stored about each ingredient, such as the exact amounts of each ingredient used to prepare each batch; each ingredient's place of origin and date of harvesting; purity and CoA information for each ingredient; information about genetic modification of the ingredients; information about the use of pesticides; information about the particular farm, or farmer, who grew and harvested each ingredient; nutrition information for each ingredient; water or soil quality information for the facilities where each ingredient was grown; and the like.

In some embodiments, the product information can include “cradle to grave” or “seed to sale” information for the products produced at the facility. In these embodiments, the portal stores the full range of available information about the products produced at the facility, or a substantial subset thereof, including information about the ingredients used at the facility, the manufacturing processes performed at the facility, and the ultimate output products. This information can then be made easily available to consumers via QR codes or other scannable barcodes, as discussed below. In these embodiments, the consumer has easy access to the full range of relevant information, which grants transparency into the manufacturing process. Such transparency could be of great value to consumers in making purchasing decisions.

Once product information has been collected and stored on the portal 100, the facility operator can give consumers easy access to that information, via QR codes (or other scannable bar codes). To do this, the facility operator can brand each batch of product produced at the facility (or the packaging of each such batch) with a QR code (or other scannable code), which encodes a URL or URI directing user devices to the product information for that batch on the portal 100. A user—for instance, deciding what to purchase at the grocery store—can scan the QR code, and instantly be directed to the product information for that batch on the portal. This can help drive purchasing decisions. For instance, if a particular consumer wishes to purchase “gluten-free” products, all of whose ingredients were grown, without pesticides, at farms within 50 miles of the consumer's home, the consumer can scan the QR code, be directed to the “product information” on the portal 100, and readily determine whether the product meets her requirements.

By way of example, assume that the facility 10 produces orange juice. Many consumers would be interested to know information about the oranges used to make the orange juice, such as: city, state and country of origin; whether the oranges were grown “organically;” when the oranges were picked; when the oranges were received at the facility; when the orange juice was made; etc. In embodiments, all of this information would be stored as “product” information in the portal 100, for each batch of orange juice produced by the facility. Each batch of orange juice produced at the facility can then be branded with a unique QR code (or other 1D or 2D barcode), which encodes a URI or URL that directs user devices 50 to the product information for that batch on the portal 100. In this way, by scanning the QR code (or other code), consumers can quickly and easily access all relevant product information for a particular carton of orange juice. In embodiments, this product information can also be verified by regulatory authorities, industry groups, or others third parties, who can ensure that the product information is accurate. This gives consumers an additional level of assurance about the product information.

While product information has been described above by reference to an example of “orange juice,” a person of ordinary skill would understand that similar information could be collected and stored on the portal 100 for virtually any type of end product. All such uses of product information are within the scope of the present disclosure.

In embodiments, another group of files on the portal 100 can be “safety” files. The “safety” group would generally contain information related to safety at the facility. Information that could be stored in the “safety” group includes, without limitation: building blueprints and plans; COAs, SDSs, MSDS, and PDSs for the products and materials used at the facility; instructions and recommendations for handling any hazardous or bio-hazardous materials at the facility; fire control information, such as the locations and types of sprinklers, fire doors and fire extinguishers within the building; safety plans, including plans for handling fires, earthquakes, hazardous material leaks, and the like; evacuation plans; contact lists; managerial information; emergency contacts; standard operating procedures; the locations within the building where particular hazardous materials are used and stored; and (if appropriate for the user) live readings from in-line telemetry sensors, indicating the levels of use or storage of hazardous materials (as described below).

In embodiments, another group of files on the portal 100 can be “manufacturing process” files. These files can describe the specific manufacturing plans, processes and procedures used at the facility to produce end-products. Different levels of “manufacturing process” information can be made available to different types of users, to protect intellectual property. For instance, management-level employee users can be given full access to all manufacturing process information, while lower-level employees may be given less access, and the general public may be given no access. First responder users may also be given emergency access, in the event of an emergency, so that the first responders can better respond to the emergency.

In some embodiments, safety information, manufacturing information, and other relevant information can be provided to first responders via the portal 100, even without an emergency. For instance, as discussed above, the portal operator can distribute a version of the reader application 400 that is provided only to first responders. This version can act like the digital equivalent of a fireman's lock box, or Knox Box, which stores keys for firefighters to use during emergencies at a facility. By appropriate authentication methods (which are known in the art), the portal operator can ensure that only legitimate first responders have access to the “first responder version” of the application. The facility operator can then give first responders heightened access to portal operations—up to and including full access to all functions available to the facility operator. For instance, the facility operator could give first responders to 24/7 access to all facility maps, hazardous materials information, and live readings from embedded facility sensors. First responders could use this information to train for potential emergencies at the facility, or to plan a response once an emergency develops. First responder-users could also develop, using the portal 100, “profiles” of facilities that have similar hazards (e.g., “all facilities using chemical X,” “all facilities operating above temperature Y,”) and develop training protocols for responding to emergencies at such facilities. Going further, facility operators could give first responders access to any shutoff values, door controls, exhaust fans, or other physical controls tied into the portal 100, so that first responders could directly control building operations as needed to respond to an emergency. As the person of skill would realize, these are merely illustrative embodiments of “first responder” applications. Many other portal functions could be configured for use by first responders, or other types of users, and all such functions are within the scope of the disclosure.

In operation, a user accesses the portal 100 through a user device 50. In preferred embodiments, the user may access the portal by scanning the scannable placard 20 at the facility 10 (or, if the user is a consumer, by scanning the QR code branded on a product made at the facility). However, appropriate classes of users may also directly access the portal 100 via the Internet, e.g., by entering the URL or IP address for the portal on a browser, or by interfacing with the portal via a dedicated application on the user device 50.

If a user seeks access to a portion of the portal that contains sensitive or confidential information, the user device can demand appropriate credentials from the user before displaying such information. For instance, the user device can demand a username and a password, a fingerprint identification, a facial identification, two-factor authorization, or any other means of identification known in the art. Or, as discussed above, the portal operator can distribute different versions of the reader application 400 to different classes of users, so that—when a particular version of the application is used to access the portal—the system immediately knows the user type. The system can then provide the appropriate level of access for that user type. For instance, if a user running a “first responder” reader application 400 accesses the portal, the system can grant a level of access appropriate to first responders (as selected by the facility operator). The system could be configured to automatically give first responders greater access—up to, and including, full access to all portal operations—in the event of an emergency. The system can be programmed to automatically detect an “emergency” condition, and automatically grant “emergency” access to first responders, in a number of ways, including by: (i) scanning embedded sensors at the facility for readings consistent with emergencies, such as high temperatures, high levels of CO/CO₂, high levels of escaped chemicals, high smoke readings, etc.; (ii) detecting the triggering of a fire alarm or other emergency alarm at the facility; (iii) allowing employees or others at the facility to manually indicate an alarm via the portal 100; or others. Such embodiments advantageously save time during emergencies, by eliminating the need for first responders to contact the facility operator and negotiate access. Alternatively, as discussed above, first responders could simply be given full access at all times, if the facility operator is comfortable with that level of access.

As shown in FIG. 2, various user devices 50, 51, 52 can be used to access the portal 100. In preferred embodiments, the portal 100 is stored and operated on a server 90. The server may be owned and operated locally by the facility operator, or it may be a cloud computing server, such as one hosted by Amazon Web Services, Microsoft Azure, Google Cloud, and the like. A facility operator, using computer 70, interfaces with the server 90 and portal 100 via a computer network 80, which may be the Internet. The facility operator can perform various operations on the portal 100, including: (i) adding new files to the portal 100; (ii) removing files from the portal 100; (iii) grouping and organizing files on the portal 100; (iv) creating and modifying the User Interface which user devices 50 will see when they access the portal 100; (v) monitoring in-line telemetry sensors (discussed below); (vi) setting conditions for automatic repurchasing and supply chain management (discussed below); (vii) creating and modifying permissions and User Interfaces for different types of users; (viii) setting and controlling access rights for users; (ix) establishing “default” views that will load for different types of users; and various other operations.

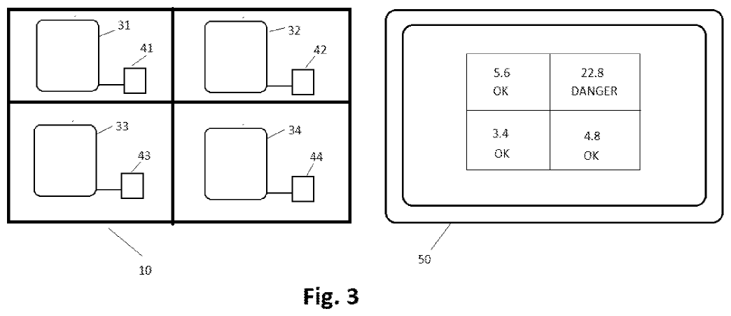

When a user device 50, 51, 52 requests access to the portal, it sends a query over the network 80 to the server 90. The portal 100 on the server 90 determines whether the user is authorized to access the portal, and if so, what level of access is permitted. The portal 100 then establishes a connection with the user device 50, 51, 52, and begins transmitting the relevant portal data. The portal data that is transmitted can be selected by the user (through a user interface), or it may be automatically determined by the portal 100 based on the type of user, or both. For instance, if the user is a first responder, and sensors in the plant indicate a fire condition (discussed below), the portal 100 may initialize the user's display to a live blueprint of the facility, overlaid with fire sensor data, as shown in FIG. 3. Alternatively, if the user is a regulator, and the portal 100 determines that the regulator has arrived to perform a site visit, the portal 100 may initialize the user's display to include all of the regulatory documentation relevant to the visit. As those of skill in the art will recognize, many other possibilities for such initialized displays are possible.

FIG. 3 depicts an embodiment in which the facility 10 is equipped with embedded sensors 41, 42, 43, 44. The left-hand side of FIG. 3 depicts an exemplary facility according to this embodiment, which has four rooms. Each room contains a facility feature (31, 32, 33, 34) connected to an embedded sensor (41, 42, 43, 44). While this exemplary embodiments contains only one feature per room, and one sensor per feature, this is for illustrative purposes only. A person of skill would recognize that a facility could have any number of rooms; that each number of rooms could have any number of features; and that each feature could have any number of embedded sensors (including zero). All such variations are within the scope of the invention.

In embodiments, the facility features (31, 32, 33, 34) can be storage tanks or containers for ingredients or materials used at the facility. For instance, the facility features may be containers that store solid, liquid or gaseous materials used as “inputs” at the facility, or containers that store solid, liquid or gaseous “outputs” of the facility. For instance, in the “orange juice” example described above, one facility feature might store the solid input—oranges—to the production process, while another facility feature might store the liquid output—orange juice—of the process. In such embodiments, the embedded sensors can detect data pertaining to the facility features to which they are connected, such as: (i) the amount of material stored in the facility feature (as measured by weight, volume, or otherwise); (ii) the rate at which the amount of material in the facility feature is increasing or decreasing; (iii) the temperature of the material in the facility feature; (iv) the pH of the material in the facility feature; (v) the chemical composition of the material in the facility feature; or any other measurable characteristics of the material.

While the embedded sensors in FIG. 3 are each depicted as being connected to a particular facility feature, a person of skill would realize that the embedded sensors could be configured otherwise. For instance, an embedded sensor could be used to measure the conditions in an entire room or wing of the facility, such as the room or wing's temperature, CO/CO₂ concentration, O₂ concentration, gas leaks, chemical leaks, humidity, or other ambient conditions.

In embodiments, live or near-live information from the embedded sensors 41, 42, 43, 44 is provided to user devices 50 via the portal 100. To accomplish this, live or near-live readings from the sensors 41, 42, 43, 44 are provided from the facility 10 to the portal 100, via the network 80, as is conventionally known. By “live” readings, what is meant are readings that are updated on a continuous basis, while by “near-live” readings, what is meant are readings that are updated on some periodic basis (e.g., every second, every 100 ms, etc.). In embodiments, an authorized user may access the portal 100 via the user device 50, and view—through a user interface—a live or near-live view of readings from the sensors 41, 42, 43, 44.

In one embodiment, live or near-live readings from the sensors may be overlaid with a blueprint or plans of the facility 10, in order to provide a particularly useful display. An illustration of this embodiment is provided on the right-hand side of FIG. 3. As shown in FIG. 3, a user device 50 may access the portal 100 and request a live overlay of sensor readings shown over a blueprint of the facility. For instance, a first responder, responding to a fire call, may request such a display to determine which rooms of the facility are particularly dangerous, or which rooms of the facility should be prioritized for firefighting efforts. As an example, in FIG. 3, the embedded sensors 41, 42, 43, 44 may each sense the levels of a flammable gas present in storage containers in each room of the facility. As an example, imagine that a level below 10 L is deemed safe, but a level above 10 L is dangerous in a fire condition. The user device—operated by, e.g., a first responder—may display a blueprint of the rooms of the facility, overlaid with the readings from each sensor. The display may indicate that the rooms with gas levels less than 10 L are “OK,” but that the rooms with gas levels above 10 L are “DANGER”—thus advising the user on which rooms should be prioritized for firefighting and rescue, which rooms should be avoided, etc.

As shown in FIG. 3, sensor readings are overlaid with a blueprint of a facility to provide a live “map” of conditions therein. However, other displays are possible. For instance, if the facility operator has taken detailed interior photographs of the facility, sensor readings could be overlaid onto a “3D walkthrough” of the facility interior, similar to the experience provided by Google Streetview. Such a 3D overlay could highlight points of interest or danger—e.g., the particular door to the room with a high concentration of flammable gas. Going further, this augmented 3D walkthrough could be streamed to an augmented reality viewing device, such as Google Glass, to allow first responders or others to view live sensor readings from the facility in 3D. As those of skill in the art would recognize, many other possibilities for displaying the sensor readings exist.

Many other uses of the sensor readings, beyond mere display on a user device 50, are also possible. For instance, a sensor reading indicating a high level of flammable gas could cause the portal 100 to issue an instruction turning off all sources of open flame in the facility. A sensor reading indicating a fire in a particular room could cause the portal 100 to control a servomotor to close the door to that room, thereby preventing spread of the fire. A vibrational sensor reading indicating potential seismic activity could cause the portal 100 to shut down operations at the facility, and issue an earthquake alert. Or, a gas sensor reading indicating that a dangerous gas has escaped containment could cause an exhaust fan, such as a C1D1 fan, to evacuate the air in the affected areas of the facility. As will be apparent to a person of ordinary skill, many other uses of the embedded sensor readings are also possible.

In other embodiments, the embedded sensors 31, 32, 33, 34 may be motion sensors, equipped to detect the presence of individuals in each room of the facility 10. Live or near-live readings from the motion sensors may be provided to the portal 100, and overlaid with a map or blueprint of the facility 10, to allow easy monitoring of movements within the facility. For instance, in this embodiment, the portal 100 can be used to monitor the movements of employees; or, they may be used to search for unauthorized access. Many other uses are possible.

In other embodiments, the embedded sensors may be smoke detectors, CO detectors, fire detectors, or the like. In such embodiments, the portal 100 may be configured to automatically contact emergency personnel if an emergency situation is detected. Along with the emergency notification, the portal 100 may also provide emergency personnel with a link to a version of the portal 100 which displays a live overlay of the emergency sensor readings—and/or other sensor readings, such as readings showing the levels of dangerous materials in different locations within the facility—over a map of the facility, to improve the emergency personnel's response.

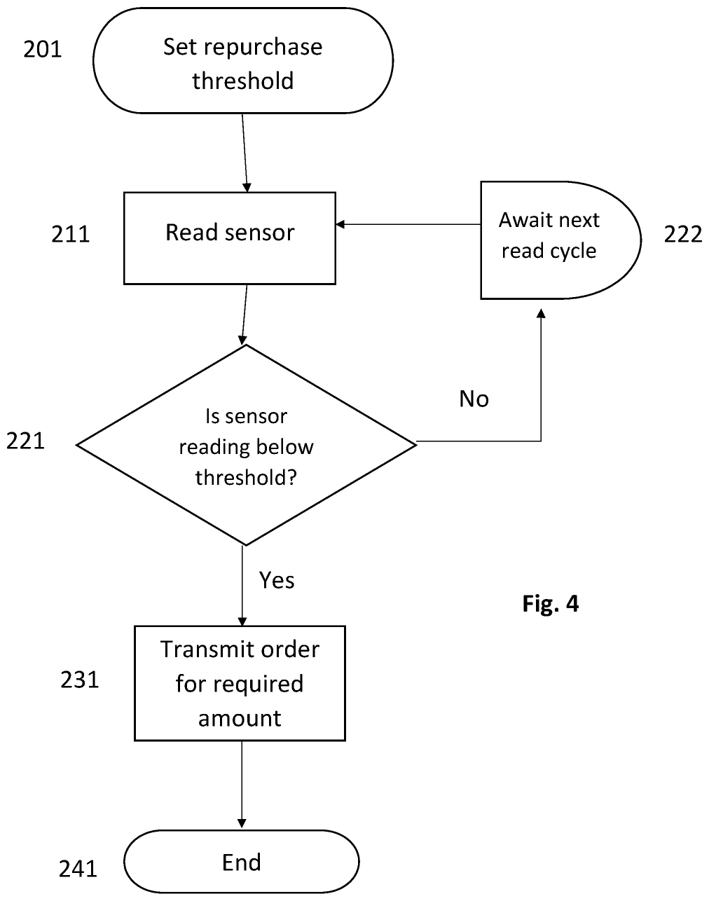

FIG. 4 is a flowchart depicting an embodiment in which embedded sensor readings are used to automatically repurchase materials needed at the facility. By way of illustration, consider an example of FIG. 1 in which facility feature 31 is a storage tank that stores a chemical needed for operations at the facility, and embedded sensor 41 detects the amount of that chemical in the tank 31. The embedded sensor 41 may be any sensor known in the art to detect quantities of materials in a container, such as an ultrasonic level sensor. Turning to FIG. 4, in step 201, the facility operator first sets (on the portal 100, or on a local computer system at the facility 10) a repurchase threshold for the material in the storage tank 31. The repurchase threshold is the level of materials in the tank 31 below which the facility operator determines that additional materials much be purchased. The facility operator can determine the repurchase threshold by considering such factors as the usage rate of the material at the facility, the storage capacity of the tank 31 (and of any extra tanks that could store the material), the risk of storing the material at the facility (e.g., the risk of accidental combustion or contamination), the delivery time required for new material to arrive at the facility 10, the risk of delivery interruptions, and any legal or regulatory restrictions on the quantity of the material that may be stored at the facility. In general, the repurchase threshold should be set at a level to ensure that the supply of necessary materials to the facility remains uninterrupted, while also avoiding the burden of storing excess amounts of the material, managing relevant risks, and complying with all legal and regulatory requirements.

After the facility operator sets the repurchase threshold in step 201, in step 211, the system (i.e., the portal 100, or a local computer at the facility 10) begins reading data from the embedded sensor 41. After each reading, the system checks, in step 221, whether the sensor reading is below the repurchase threshold. If not, then the system begins another read cycle—potentially with a delay period (e.g., 100 ms, 1 s, 10 s, etc.) 222 before each new read. The system continues to check the sensor until it determines, in step 221, that the level of material in the tank 31 is below the repurchase threshold. At that point, in step 231, the system (i.e., either the portal 100, or a local computer at the facility 10) issues an automatic electronic order to the facility's supplier for the material, in a manner known in the art. Alternatively, in step 231, the system can issue a reorder “reminder” to the facility operator, if the facility operator does not wish to use automatic ordering. When automatic ordering is used, the facility operator can set the order to repurchase an appropriate amount of the material, based on the facility's expected usage rate of the material, the storage capacity of the tank 31, the delivery time, and the like.

While, in the foregoing, the embodiment of FIG. 4 was described by reference to an embodiment in which a single storage tank 31 is monitored for repurchasing, those of skill in the art would know that any number of facility features 31, 32, 33, 34, etc. can be monitored, by corresponding embedded sensors 41, 42, 43, 44, etc., for repurchasing, Furthermore, while this embodiment was described by reference to repurchasing a “chemical” material, those of skill in the art would know that the same technique can be applied to repurchase other materials.

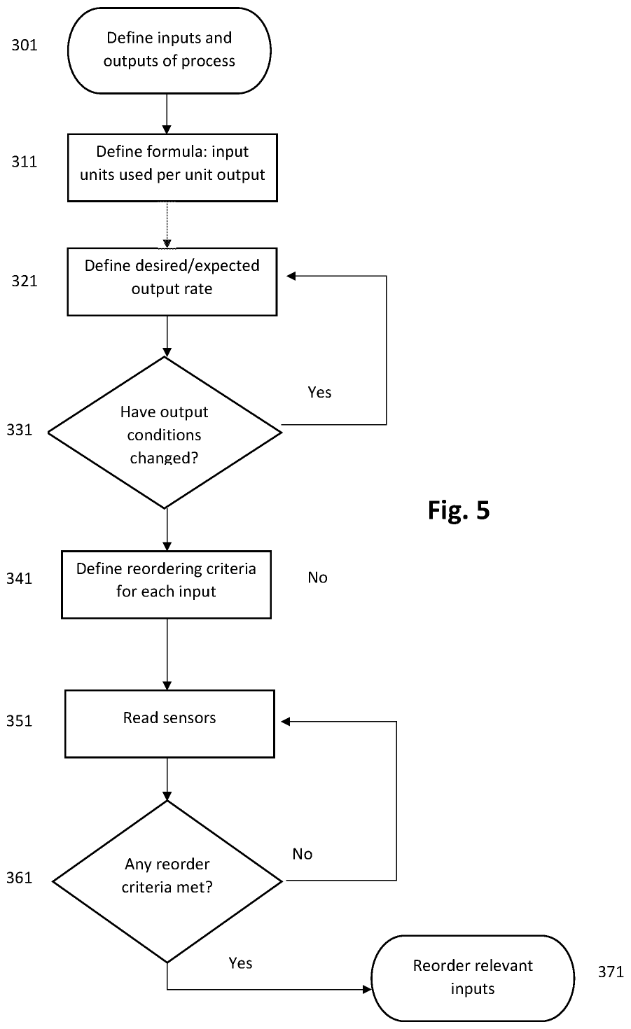

FIG. 5 is a flowchart depicting an embodiment in which the supply chain of the facility 10 is automatically managed based on the embedded sensor readings. By way of illustration, this embodiment can be explained by reference to the facility depicted in FIG. 3. In this illustrative example, the four facility features 31, 32, 33, 34 are storage containers for four “input” materials needed at the factory (e.g., ingredients, chemicals, raw materials, etc.), and the four embedded sensors 41, 42, 43, 44 measure: (i) the level of materials in the corresponding containers; and/or (ii) the rate of use of materials in each container (e.g., by taking the time derivative of the level). In this embodiment, the facility operator can set a program in the portal 100 (or in a local computer at the facility 10) to automatically control the repurchasing of the required materials.

In step 301, the facility operator defines (in the portal 100, or in a local computer at the facility 10) the inputs and outputs of the process. For instance, the facility operator can define that the “inputs” are the materials in containers 31, 32, 33 and 34, and that the “output” is some end-product. In step 311, the facility operator defines (in the portal 100, or in a local computer at the facility 10) the quantity of each input material needed to produce one unit of output material. This could be a simple linear relationship (e.g., one output unit=W units of material A, X units of material B, Y units of material C, and Z units of material D), or a more complicated relationship, as required based on the process. In step 321, the facility operator defines (in the portal 100, or in a local computer at the facility 10) the desired or expected output rate of the process. This can be determined based on a number of factors, including historical measurements of demand (potentially on a seasonal, monthly, weekly, or other basis), projections of future demand, inventory capacity for excess units, and others. In step 331, if the desired or expected output conditions of the process have changed, the facility operator may modify them (in the portal 100, or in a local computer at the facility 10). For instance, if a change in demand is anticipated, or the facility 10's inventory capacity changes, the output rate may be changed accordingly.

In step 341, the facility operator defines reordering criteria for each input material. Similar to the embodiment of FIG. 4 discussed above, in this step, the facility operator sets “thresholds” for when new supplies of each input material should be repurchased. However, rather than being a simple static “threshold” as in FIG. 4, here, the reordering criteria for each input material may take into account factors such as the desired/expected output rate, as well as the reordering criteria for the other input materials, since—in many processes—each input material is a “bottleneck,” of which there must be adequate supply before any output can be created. The reordering criteria may also consider factors such as inventory capacity, delivery time, and the like.

In step 351, the portal 100 (or a local computer at the facility 10) reads the embedded sensors. In step 361, the portal 100 (or a local computer at the facility 10) determines whether the reordering criteria for any of the input materials have been met. If none of the criteria have been met, then another read cycle begins. If one or more of the criteria have been met, then—in step 371—the portal 100 (or local computer at the facility 10) issues an automatic order for the appropriate amount of the relevant input materials. The appropriate amount to reorder can be determined based on the desired output rate, the facility's inventory capacity, and other relevant factors. Alternatively, rather than automatically sending an order, the portal 100 (or local computer at the facility 10) can issue a reorder “reminder” to the facility operator.

In embodiments, the present invention can also be used to streamline and improve inventory, order processing, and accounting operations at the facility 10. For instance, assume that (as shown in FIG. 1) the facility 10 has a prominently displayed placard 20. Assume that a vendor makes a delivery of an ingredient for the facility, which is to be stored in tank (facility feature) 31. After making the delivery, the delivery driver—perhaps using a “delivery driver” version of the reader application 400—can scan the placard. This can send a message to the portal, indicating that the delivery has been completed. This message can be communicated to the facility operator, and to the vendor, to confirm receipt. Subsequently, once the delivery is loaded into tank 31, the sensor 41 can report that the expected amount of the ingredient was actually received. This, too, can be reported to the facility operator and the vendor, to confirm that the contract was satisfied. This allows both parties to automatically confirm satisfactory delivery, and deem the contract closed. Upon request, all of this information could also be provided to regulators. This would allow regulators to confirm exactly when deliveries were received, the quantities delivered, and the exact dates/times when the materials were loaded into the tank 31. This could all be done in a “virtual” inspection, as described above - eliminating the need for disruptive on-site inspections.

In the foregoing embodiments, the facility 10 was generally described by reference to the features typically found in industrial, manufacturing or agricultural facilities. However, the present invention is not limited to use in industrial, manufacturing or agricultural facilities. The present invention could also be used in, for example, residential facilities, commercial facilities, office facilities, retail facilities, or any other type of facility.

If the facility 10 is a residential facility (such as an apartment complex), the facility features 31, 32 et al. could be rooms of the facility, floors of the facility, doors within the facility, wings of the facility, or any other subdivision of the facility. The embedded sensors 41, 42 et al. could be any sensors suitable for use in a residential facility, such as smoke detectors, CO detectors, earthquake detectors, motion sensors, RFID tag readers, and the like. The portal could store the same general types of information for residential facilities as described above for general facilities—e.g., regulatory information, safety information, and the like. This information could be customized, however, for the residential context. For instance, in a residential building, “regulatory” information could include ADA compliance information, fire code information, occupancy information, and other information relevant to the regulation of residential facilities. Meanwhile, “safety” information could include occupancy information, and could even include information about specific residents of the facility, which could be useful to first responders. For instance, the “safety” information could include the identities and locations of facility occupants who are handicapped (ADA), elderly or ill. This information could be provided to first responders during, or before, an emergency, to allow them to provide appropriate rescue services.

For example, an operator of a residential facility could ask all residents to list their normal work hours, and store that information on the portal 100. If there is an emergency at the facility, first responders could be given access to that information. That would assist first responders in determining which rooms are likely to be occupied (based on the day and time), thus allowing them to prioritize rescue operations in the most-likely occupied rooms. Going further, the facility operator could install motion sensors, cameras, or other sensors within the facility, and make those sensor readings available to first responders. In an emergency, first responders could consult those readings to determine where people in the facility are located, thus allowing them to prioritize the most-occupied areas. As a person of skill would recognize, these are just illustrative examples of some ways that the present invention could be applied in residential facilities. Other applications are also possible, and all such applications are within the scope of the disclosure.

In the foregoing, certain embodiments were described as using a “scannable placard,” wherein a user accesses the portal by scanning the placard. However, the invention does not require the use of scannable placards. In other embodiments, users can access the portal remotely, without scanning a placard. For instance, in some embodiments, users can access the portal by visiting a particular Internet location, e.g., in a web browser. In other embodiments, users can access the portal via a dedicated application, such as the reader application 400 described above. In other embodiments, users can access the portal by using a VPN, a remote desktop, or any other means of remote access to computing systems. As a person of skill would know, many means of remote computer access are known in the art, and all such means are within the scope of the disclosure.

The systems and methods described herein provide several advantages over the prior art. First, the ability to collate all significant information pertaining to a facility in one convenient location greatly enhances ease-of-use for employees, regulators, first responders, and others. The ability for visitors at the facility to instantly access all information relevant to their interests, by scanning a scannable placard, further enhances ease-of-use. Usability is even further enhanced by the ability of facility operators to configure which information from the portal is displayed to each user type, and to configure how that information is displayed to each user type. Safety is enhanced by the ability to provide live sensor readings, overlaid with maps or images of the facility, to first responders and others. Facility efficiency is enhanced by the ability to use embedded sensor readings to automate repurchase of materials needed at the facility. These advantages, and others, will be apparent to those of skill in the art from the disclosure provided herein.

While the present invention has been described by reference to the foregoing embodiments, those of skill in the art will recognize that other modifications, variations or combinations of these embodiments are within the scope of the invention, and can be made without undue experimentation. Applicant intends the present invention to cover all such modifications, variations and combinations, as well all other embodiments readily apparent to a person of skill.

What is claimed is:

1. A system for controlling and accessing facility operations and information, comprising:
a server; and
a portal stored on the server, wherein the portal is linked to a facility, wherein at least one process is performed at the facility, and wherein the facility includes:
at least one facility feature, and
at least one embedded sensor;
wherein the portal stores information about the facility;
wherein the information stored on the portal includes at least one of: readings from the embedded sensors, regulatory information about the facility, a blueprint or map of the facility, safety information about the facility, information about the process(es) performed at the facility, and information about the products made, or materials or ingredients used, at the facility;
wherein a facility operator may select or modify the information stored on the portal; and
wherein at least one user device can access the portal, via a network, to view some or all of the information stored on the portal.

2. The system of claim 1, further comprising:
a scannable placard located at the facility;
wherein a user device may scan the scannable placard; and
wherein, when a user device scans the scannable placard, the user device is directed to the portal, to view some or all of the information stored on the portal.

3. The system of claim 2, wherein the scannable placard includes a 1D or 2D barcode, and wherein the user device can scan the placard by scanning the barcode.

4. The system of claim 3, wherein the 1D or 2D barcode is a QR code.

5. The system of claim 1, wherein the portal is configured to be accessed by a plurality of different user types, and wherein the information displayed to a user device depends on its user type.

6. The system of claim 5, wherein the portal is configured so that only authorized information is displayed to the user device, based on at least one of: the user type and a user's access credentials.

7. The system of claim 6, wherein the manner in which the information is displayed on the user device is customized based upon, at least, the user type.

8. The system of claim 1, wherein at least one of the embedded sensors is linked to at least one of the facility features, and wherein the linked embedded sensor(s) provide data about the facility feature(s) to which they are linked to the server or another computer.

9. The system of claim 8, wherein the server or other computer is configured to generate a repurchase order based upon data from the linked embedded sensor(s).

10. The system of claim 1, wherein the portal stores at least a blueprint or map of the facility and readings from the embedded sensors, wherein the server is configured to generate a combined image that overlays readings from the embedded sensors onto the blueprint or map, and wherein the server is configured to transmit the combined image to a user device.

11. A method of controlling and accessing facility operations and information, comprising:
providing a server;
providing a portal on the server;
linking the portal to a facility, wherein the facility is configured to perform at least one process, and wherein the facility includes:
at least one facility feature; and
at least one embedded sensor;
storing information about the facility on the portal, wherein the information stored on the portal includes at least one of: readings from the embedded sensors, regulatory information about the facility, a blueprint or map of the facility, safety information about the facility, information about the process(es) performed at the facility, and product information about the products made, or materials or ingredients used, at the facility;
receiving, at the server, a request from at least one user device to access information on the portal; and
in response to a request from a user device, providing some or all of the information on the portal to the user device, over a network.

12. The method of claim 11, wherein the facility further includes a scannable placard, and wherein the method further comprises:
receiving, at the server, a request for a user device to access the portal, based on the user device having scanned the scannable placard; and
providing some or all of the information on the portal to the user device, over a network, in response to the request based on scanning the scannable placard.

13. The method of claim 12, wherein the scannable placard includes a QR code, and wherein the user device generates the request by scanning the QR code.

14. The method of claim 11, further comprising:
establishing a plurality of user types for the portal;
determining the user type of a user device that requests access to the portal; and
selecting which information from the portal to provide to the user device based, at least in part, upon the user device's user type.

15. The method of claim 14, further comprising customizing the manner in which the information from the portal is displayed on the user device based on, at least, the user type.

16. The method of claim 11, further comprising:
performing the at least one process at the facility to generate an output product;
storing, on the portal, information about the output product, or about the materials or ingredients used to generate the output product;
generating a unique 1D or 2D barcode that encodes a link to information on the portal about the output product, or about the materials or ingredients used to generate the output product;
branding the output product, or its packaging, with the unique 1D or 2D barcode; and
in response to user device requests generated by scanning the unique 1D or 2D barcode, providing information about the product, or about the materials or ingredients used to generate the product, to the requesting user device(s).

17. The method of claim 11, wherein the information stored on the portal includes at least readings from the embedded sensors and a blueprint or map of the facility, the method further comprising:
generating a combined image that overlays readings from the embedded sensors onto the blueprint or map of the facility; and
displaying the combined image on a user device.

18. The method of claim 11, wherein at least one of the facility features is a storage unit, the method further comprising:
linking at least one of the embedded sensors to at least one of the storage unit(s);
storing input materials for the at least one process in the at least one storage unit(s);
configuring the linked embedded sensor(s) to provide, to the server or another computer, data about the quantity of materials stored in the storage unit(s);
setting, on the server or other computer, a repurchase threshold for the materials stored in each of the storage unit(s);
reading, at the server or other computer, data from the embedded sensors about the quantity of materials stored in the storage unit(s);
determining, based on the data from the embedded sensors, whether the quantity of input materials stored in any of the storage unit(s) is below that storage unit's repurchase threshold; and
if the quantity stored in a storage unit is below its repurchase threshold, generating, from the server or other computer, a repurchase order for the materials stored in the storage unit.

19. The method of claim 18, further comprising:
permitting a facility operator to monitor, modify or control the repurchase threshold(s) or repurchase order(s) through the portal.

20. The method of claim 18, further comprising:
defining, at the server or other computer, the inputs and outputs of the at least one process, wherein the input materials are stored in the at least one storage unit(s);
defining, at the server or other computer, a relationship between the quantities of inputs used and quantities of outputs generated in the at least one process;
defining, at the server or other computer, a desired or expected rate of output from the at least one process; and
setting the repurchase thresholds for the materials stored in the storage unit(s) based upon at least one of: (i) the relationship between the quantities of inputs used and quantities of outputs generated; and (ii) the desired or expected rate of output.
